(19) United States
(12) Patent Application Publication
(10) Pub. No.: US 2013/0236676 A1
(43) Pub. Date: Sep. 12, 2013

(54) APPARATUS AND METHOD FOR PROTECTING A FLOOR AND BASEBOARD

(71) Applicant: Richard Doyle, Rochester, NY (US)

(72) Inventor: Richard Doyle, Rochester, NY (US)

(21) Appl. No.: 13/416,523

(22) Filed: Mar. 9, 2012

(51) Int. Cl. B32B 3/02; B23P 17/00

(52) U.S. Cl. 428/57; 29/428

(57) ABSTRACT

Disclosed in this specification is a protective cover for baseboards. The protective cover comprises a central, rigid panel with an upper surface and first and second baseboard protectors flexibly attached thereto.

### FIELD OF THE INVENTION

This invention relates, in one embodiment, to the protection of hallway floors and baseboards from damage while moving large objects through the hallway.

### BACKGROUND

When a construction or renovation project is undertaken in a commercial building, office building or residential home, the work performed during the project may cause damage to the floors, baseboards and walls of the building. For example, when a homeowner moves into a new home, major pieces of furniture and equipment (sofa, beds, televisions) are often carried by movers through narrow hallways to place the furniture and equipment at a desired location. Likewise, during renovation of one more rooms or offices, construction workers may have to traverse halls and corridors to carry building supplies and equipment to the renovation site. During this process floors, baseboards and walls of the hallways may be scratched, nicked or otherwise damaged.

Protective flat mats or cloths are often placed on the floor of the hallway to protect the floor and/or carpet but these to little to protect the baseboards. That often requires the contractor to repair and repaint the baseboards and perhaps entire walls if the lower portions of the wall are damaged. Therefore, a mechanism is desired for protecting the baseboard from damage.

### SUMMARY OF THE INVENTION

Disclosed in this specification is a system for protecting floors and baseboards.

In one exemplary embodiment, a protective cover is disclosed. The protective cover comprises a central, rigid panel with an upper surface and first and second baseboard protectors flexibly attached thereto.

In a second exemplary embodiment, a protective cover is disclosed that is comprised of a central panel of rigid hardboard with an upper surface. First and second baseboard protectors, formed of cardboard, are flexibly attached thereto.

In a third exemplary embodiment, a method for protecting baseboards is disclosed. A protective cover is placed on a floor such that a central panel of rigid hardboard contacts the floor, the central panel having an upper surface facing upwards. The protective cover includes first and second baseboard protectors, formed of cardboard, that are flexibly attached to the central panel. These baseboard protectors are permitted to be disposed over the baseboards of the hallway to provide protection.

### BRIEF DESCRIPTION OF THE DRAWINGS

The present invention is disclosed with reference to the accompanying drawings, wherein:

FIG. 1 is a perspective view of an exemplary protective cover disposed in a hallway;

FIG. 2 is a plan view of the top of an exemplary protective cover;

FIG. 3 is a plan view of the bottom of the protective cover of FIG. 2;

FIG. 4 is a plan view of the top of the protective cover of FIG. 2 shown in a partially folded configuration; and

FIGS. 5A and 5B are profile views of the protective cover showing positioning in two hallways of different sizes.

Corresponding reference characters indicate corresponding parts throughout the several views. The examples set out herein illustrate several embodiments of the invention but should not be construed as limiting the scope of the invention in any manner.

### DETAILED DESCRIPTION

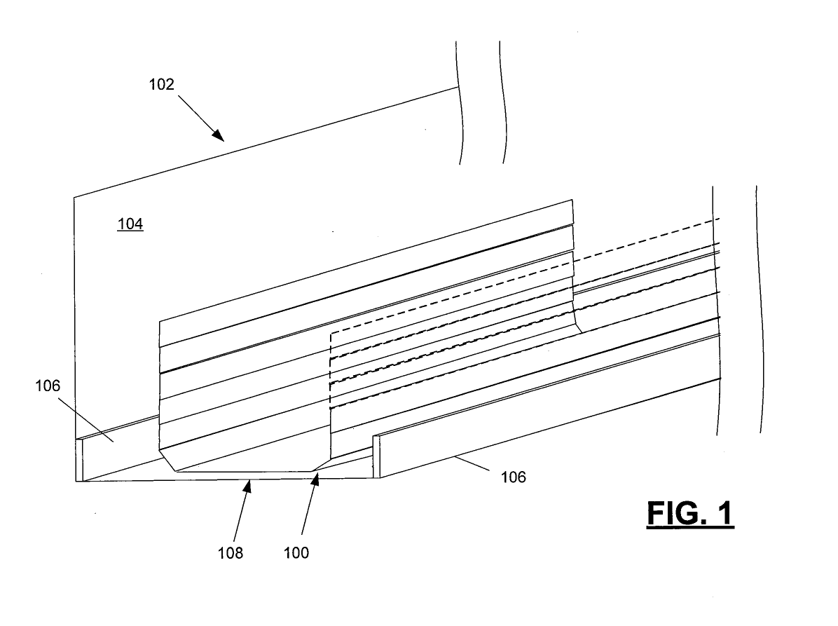

FIG. 1 is a perspective view of protective cover 100 for protecting a hallway 102 with walls 104. Protective cover 100 protects the floor 108, two flanking baseboards 106 and, in certain embodiments, a portion of walls 104 from damage and/or debris.

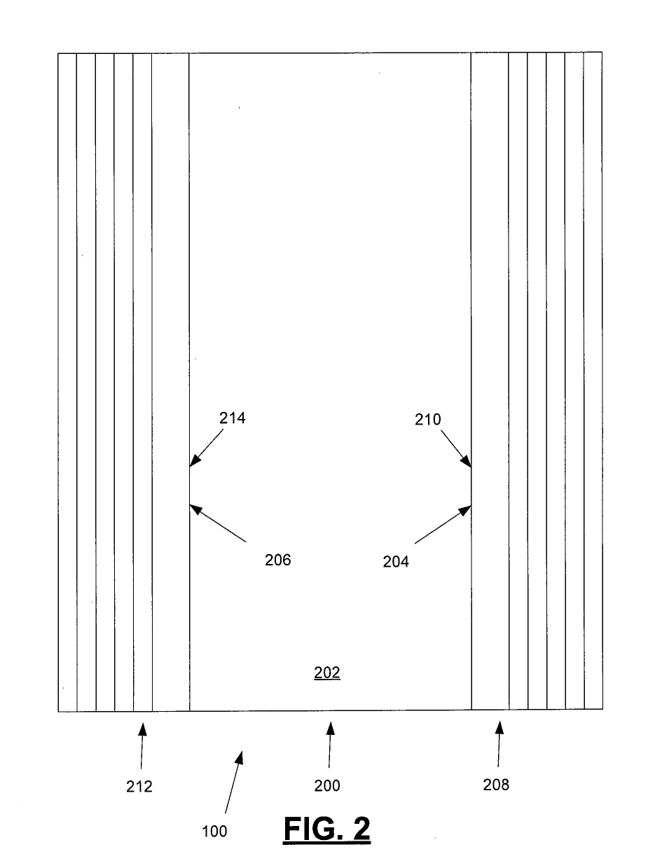

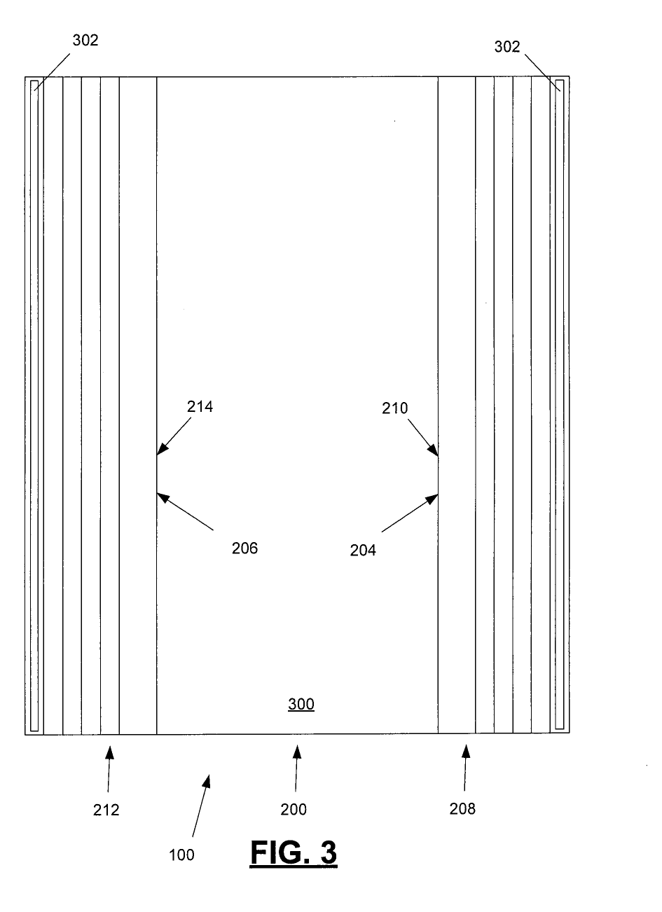

FIG. 2 is a top plan view of protective cover 100. Protective cover 100 comprises an elongated central panel 200 with an upper surface 202. In one embodiment, upper surface 202 is smooth to promote objects (e.g. furniture, appliances, etc) sliding or rolling on hand trucks along its surface. Central panel 200, in one embodiment, is formed of a rigid material such as plywood, particle board, hard board, fiber board, insulating board, composite board, construction board and synthetic or artificial lumber. Central panel 200 includes first and second elongated edges, 204, 206 which traverse the length of the central panel 200. Flexibly attached to first and second elongated edges, 204, 206 are first and second baseboard protectors 208, 212, respectively. First and second baseboard protectors 208, 212 are joined to the central panel 200 at first and second proximal edges 210 and 214 by, for example, flexible tape, hinges, or other suitable means. Baseboard protectors 208, 212 are each formed, or covered with, a relatively soft material compared to central panel 200. In one embodiment, baseboard protectors 208, 212 are formed of cardboard. FIG. 3 depicts a bottom plan view of protective cover 100. In one embodiment, bottom surface 300 is textured to provide a relatively high coefficient of friction, compared to upper surface 202, which helps keep protective cover 100 in place on the floor after it has been properly positioned. In one embodiment, the bottom-side of first and second baseboard protectors 208, 212 include a strip of adhesive 302 along their distal edges. The strip of adhesive 302 may, for example, be adhesive tape that is covered by a release layer. Adhesive 302 helps the protective cover 100 adhere to the walls and helps prevent debris from contaminating the underlying floor.

In use, protective cover 100 is placed in a hallway such that bottom surface 300 contacts floor 108 while upper surface 202 is facing upwards to provide a surface upon which furniture can be slid. In those embodiments where bottom surface 300 has a relatively high coefficient of friction, it generally adheres to floor 108 (e.g. a carpeted hallway) and prevents protective cover 100 from sliding. Central panel 200 has a width selected to span the width of a variety of common hallways. In one embodiment, central panel 200 has a width of about two feet. For other applications, where hallways sizes may be different, other suitable widths are selected.

Baseboard protectors 208, 212 fold upwards toward upper surface 202 when their respective distal edges contact walls 104. In this fashion, baseboards 106 and a portion of walls 104 are protected from impact as objects are moved across upper surface 202. In one embodiment, adhesive 302 is present. In such an embodiment, the release layer is removed to reveal adhesive 302. Adhesive 302 is thereafter placed against wall 104. The adhesive may be a mild adhesive that readily releases from the baseboard or wall, such as the type of adhesive used for masking tape. This helps keep baseboard protectors 208, 212 properly positioned against the wall 104 as well as keeps the protective cover from traversing the length of the hallway 102 due to gradual creeping during use.

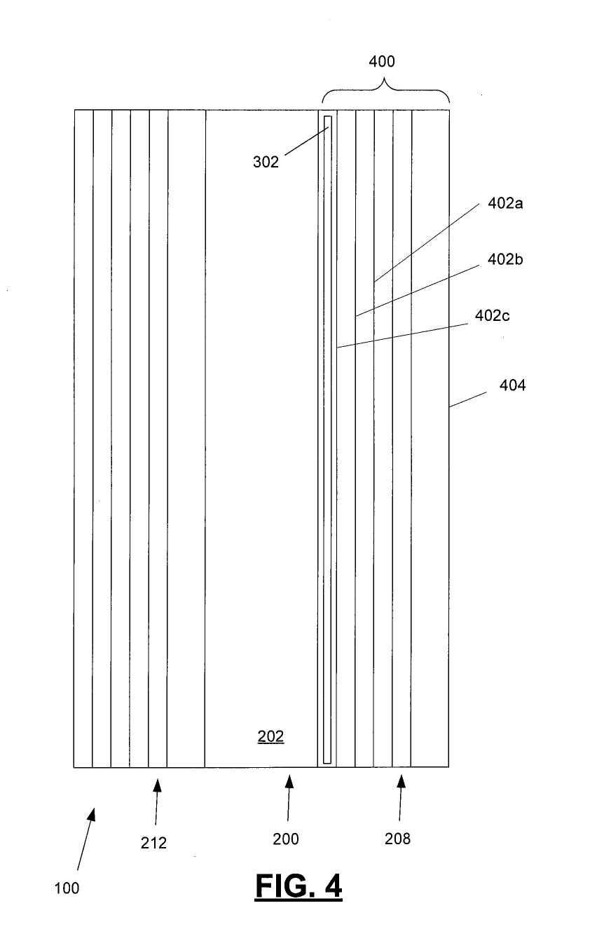

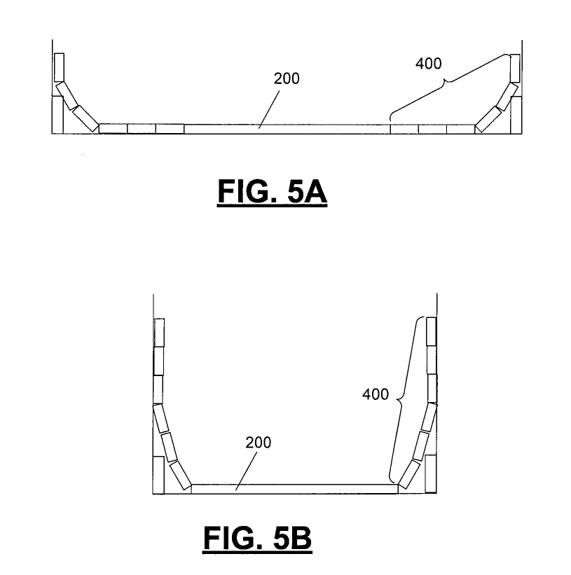

In the embodiment shown in FIG. 4, each of the baseboard protectors 208, 212 has at least one area 400 separated by scores lines 402a-c, about which the baseboard protectors 208, 212 may bend. Scores lines 402a-c may be on the bottom surface, the top surface, or both the bottom and top surface of baseboard protectors 208, 212. By supplying several score lines at different distances along the baseboard protectors 208, 212, small variations in hallway width may be accommodated. For example, in narrow hallways, the bend in the baseboard protector may occur at score line 402a while in wider hallways the bend may occur at score line 402c. See FIGS. 5A and 5B.

FIG. 4 depicts protective cover 100 in a partially folded configuration. In FIG. 4, first baseboard protector 208 has been folded about fold-line 404 atop central panel 200 while second baseboard protector 212 remains extended. Baseboard protectors 208, 212 have a width equal to or less than the width of central panel 200. In the embodiment depicted, first baseboard 208 has a width of about two-thirds the width of central panel 200. For example, when central panel 200 is three feet wide, each of the baseboards protectors 208, 212 may be two feet wide. In such an embodiment, the width of baseboard protectors 208, 210 extends to protect not only the baseboard, but also a portion of the wall. Areas 400 are provided at the distal end of the respective baseboards protectors 208, 212 which are, in one embodiment, two inches wide and traverse the length of the baseboards protectors 208, 212.

FIGS. 5A and 5B illustrate the protective cover in two hallways of different sizes. In FIG. 5A, which shows a relatively wide hallway, three areas 400 are flat against the floor and three areas 400 curve upward against the wall. In FIG. 5B, when shows a relatively narrow hallway, central panel 200 is flat again the floor and six areas 600 curve upward against the wall. In a hallway with a width between that shown in FIGS. 5A and 5B, select smaller areas 400 may rest flat against the floor with a bend occurring along one of the score lines as described above.

The above embodiments show relatively narrow protector strips that are wide enough to cover at least the baseboards on opposite sides of the hall. However, the invention also contemplates wider strips that would cover at least the lower portion of the wall. The embodiment with wider strips would protect the lower portion of the wall from accidental impacts of hand trucks, equipment, furniture and tools. In addition, any debris impacting the wall would be channeled by the wider protector strips to fall onto the center panel.

In use, several protective covers 100 may be used to span the length of a complete hallway. For example, several protective covers 100 may be laid in series (end-to-end) to provide a continuous surface for sliding furniture along while the corresponding baseboards are protected.

While the invention has been described with reference to certain embodiments, it will be understood by those skilled in the art that various changes may be made and equivalents may be substituted for elements thereof to adapt to particular situations without departing from the scope of the disclosure. For example, the cardboard protector strips are envisioned as flat, elongated sheets with longitudinal score on their bottom surface to permit the user to arrange the strips up to and over the baseboards. In an alternate embodiment the cardboard could have an accordion-like fold so that it could be extended and positioned over the baseboards. Cardboard is one material for the protector strips, but other materials could be substituted, including and not limited to durable poster board and other suitable materials. Therefore, it is intended that the claims not be limited to the particular embodiments disclosed, but that the claims will include all embodiments falling within the scope and spirit of the appended claims.

What is claimed is:

1. A protective cover for placement on a floor of a hallway for protecting the floor and two flanking baseboards, the protective cover comprising:
an elongated central panel formed of a rigid material, the central panel having an upper surface, a first elongated edge and a second elongated edge opposite the first elongated edge;
a first baseboard protector flexibly attached to the first elongated edge;
a second baseboard protector flexibly attached to the second elongated edge.

2. The protective cover as recited in claim 1, wherein the first baseboard protector has at least one lower scoring line on a bottom surface which is opposite the upper surface of the elongated central panel, the lower scoring line running parallel to the first elongated edge.

3. The protective cover as recited in claim 2, wherein the second baseboard protector has at least one lower scoring line on a bottom surface which is opposite the upper surface of the elongated central panel, the lower scoring line running parallel to the second elongated edge.

4. The method as recited in claim 1, wherein the first baseboard protector has at least two lower scoring lines on a bottom surface which is opposite the upper surface of the elongated central panel, the lower scoring lines running parallel to the first elongated edge.

5. A protective cover for placement on a floor of a hallway for protecting the floor and two flanking baseboards, the protective cover comprising:
an elongated central panel formed of a rigid hardboard, the central panel having an upper surface, a first elongated edge and a second elongated edge opposite the first elongated edge;
a first baseboard protector formed of cardboard flexibly attached at a first proximal edge to the first elongated edge;
a second baseboard protector formed of cardboard flexibly attached at a second proximal edge to the second elongated edge.

6. The protective cover as recited in claim 5, wherein the first baseboard protector has at least one lower scoring line on a bottom surface which is opposite the upper surface of the elongated central panel, the lower scoring line running parallel to the first elongated edge.

7. The protective cover as recited in claim 6, wherein the second baseboard protector has at least one lower scoring line on a bottom surface which is opposite the upper surface of the elongated central panel, the lower scoring line running parallel to the second elongated edge.

8. The protective cover as recited in claim 7, wherein the first baseboard protector has at least one upper scoring line on a top surface which is on the same side of the protective cover as the upper surface of the elongated central panel, the upper scoring line running parallel to the first elongated edge.

9. The protective cover as recited in claim 8, wherein the second baseboard protector has at least one upper scoring line on a top surface which is on the same side of the protective cover as the upper surface of the elongated central panel, the upper scoring line running parallel to the second elongated edge.

10. The protective cover as recited in claim 6, wherein the first baseboard protector further comprises an elongated adhesive strip running parallel to the first elongated edge, the adhesive strip being disposed on the bottom surface which is opposite the upper surface of the elongated central panel and on a distal edge of the first baseboard protector that is opposite the first proximal edge.

11. A method for protecting the floor and two flanking baseboards of a hallway comprising the steps of:
placing a first protective cover in an elongated hallway with a floor and a first and second baseboard flanking the floor, the first protective cover comprising:
an elongated central panel formed of a rigid hardboard, the central panel having a upper surface, a first elongated edge and a second elongated edge opposite the first elongated edge;
a first baseboard protector formed of cardboard flexibly attached at a first proximal edge to the first elongated edge;
a second baseboard protector formed of cardboard flexibly attached at a second proximal edge to the second elongated edge;
allowing the central panel to contact the floor such that the upper surface faces upwards;
permitting the first and second baseboard protectors to be disposed over the first and second baseboards thereby protecting the first and second baseboards.

12. The method as recited in claim 11, wherein the first baseboard protector has at least two lower scoring lines on a bottom surface which is opposite the upper surface of the elongated central panel, the lower scoring lines running parallel to the first elongated edge.

13. The method as recited in claim 11, wherein the first baseboard protector further comprises an elongated adhesive strip running parallel to the first elongated edge, the adhesive strip being disposed on a bottom surface which is opposite the upper surface of the elongated central panel and on a distal edge of the first baseboard protector that is opposite the first proximal edge.

14. The method as recited in claim 11, further comprising the step of sliding a piece of furniture over the upper surface.

15. The method as recited in claim 11, further comprising the step of placing a second a protective cover end-to-end with the first protective cover, wherein the second protective cover is substantially identical to the first protective cover.
